(19) United States
(12) Patent Application Publication
(10) Pub. No.: US 2009/0138630 A1
(43) Pub. Date: May 28, 2009

(54) STORAGE SYSTEM AND EXTERNAL VOLUME CONNECTION PATH SEARCHING METHOD FOR STORAGE SYSTEM

(76) Inventors: Koji YASUTA, Hiratsuka (JP); Atsushi MIYAGAKI, Odawara (JP); Keishi TAMURA, Fujisawa (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/034,948

(22) Filed: Feb. 21, 2008

(30) Foreign Application Priority Data
Nov. 26, 2007 (JP) 2007-304753

(51) Int. Cl. G06F 3/00

(52) U.S. Cl. 710/38

(57) ABSTRACT

In a storage system including: a host, a first storage apparatus, a second storage apparatus connected to the first storage apparatus via a communication line, and a management apparatus that manages the first storage apparatus and the second storage apparatus, the host and the first storage apparatus being connected to each other via the communication line; and the host using a volume in the second storage apparatus as an external volume for the first storage apparatus, the first storage apparatus includes: a port search processing unit that searches for communication ports of the second storage apparatus; and a volume search processing unit that searches for connection paths to a volume in the second storage apparatus by utilizing any of the communication ports found in the port search processing unit and outputs all the information about the found connection paths to the volume.

### CROSS-REFERENCES TO RELATED APPLICATIONS

This application relates to and claims priority from Japanese Patent Application No. 2007-304753, filed on Nov. 26, 2007, the entire disclosure of which is incorporated herein by reference.

### BACKGROUND

1. Field of the Invention

The invention relates generally to a storage system and an external volume connection path search method for the storage system, and is suitable for use in, for example, a storage system that searches for connection paths to a volume in an external storage apparatus and an external volume connection path search method for the storage system.

2. Description of Related Art

There is a storage system in which a main storage apparatus is connected to a storage apparatus serving as an external storage apparatus via a fibre cable or similar so that a volume in the external storage apparatus can be used as an external volume. As a result, the storage system has increased storage resources, enabling processing for higher-capacity data.

Also, the above storage system has a configuration in which the storage apparatus and the external storage apparatus are connected via plural paths. With that configuration, when a fault occurs in a path, access to the external volume is realized using another path, improving resistance against path faults.

A technique for a path control method is known in which, in a storage system in which an external storage apparatus is connected to a storage apparatus, the storage apparatuses are connected via plural paths in a switchable manner; and when a fault occurs in a path, the path having the next highest priority is selected to continue processing, in order to achieve improved ease of use and reliability (see, e.g., JP2006-178811 A).

In the above storage system, a unique path for an external volume is determined based on a port, WWN (World Wide Name), and LUN (Logical Unit Number). For this reason, processing for acquiring “Inquiry” information is required, in which the “Inquiry” information is detected from each connection path for setting an alternate path for the relevant external volume and detecting volumes having corresponding information (e.g., device identifier) specifying a device based on the acquired information. Therefore, search is required for, at the maximum, the number of ports×the number of WWNs×the number of LUNs in order to specify a desired external volume. Executing the above processing requires time for searching for a desired external volume and causes heavy traffic.

### SUMMARY

The present invention has been made in light of the above, and an object of the invention is to provide a storage system with which a user can search for connection paths to an external volume with ease and for a short time, and an external volume connection path search method for the storage system.

According to the invention, provided is a storage system including: a host, a first storage apparatus, a second storage apparatus connected to the first storage apparatus via a communication line, and a management apparatus that manages the first storage apparatus and the second storage apparatus, the host and the first storage apparatus being connected to each other via the communication line; and the host using a volume in the second storage apparatus as an external volume for the first storage apparatus, characterized in that the first storage apparatus includes: a port search processing unit that searches for communication ports of the second storage apparatus; and a volume search processing unit that searches for connection paths to a volume in the second storage apparatus by utilizing any of the communication ports found in the port search processing unit and outputs all the information about the found connection paths to the volume.

With this configuration, the information about the connection paths to the external volume in the second storage apparatus can be acquired at once by utilizing any of the found communication ports.

According to the invention, a storage system with which a user can search for connection paths to an external volume with ease and for a short time, and an external volume connection path search method for the storage system can be provided.

Other aspects and advantages of the invention will be apparent from the following description and the appended claims.

### BRIEF DESCRIPTION OF THE DRAWINGS

FIG. 1 is a diagram schematically showing an overall configuration for a storage system according to a first embodiment of the invention.

FIG. 2 is a diagram showing configurations for a storage apparatus and an external storage apparatus according to the embodiment.

FIG. 3 is a diagram showing logical storage structures of an storage apparatus and an external storage apparatus according to the embodiment.

FIG. 4 is a procedure for making a volume in an external storage apparatus usable as an external volume in a storage system according to the embodiment.

FIG. 5 is a flowchart showing external volume search processing according to the embodiment.

FIG. 6 is a diagram showing a port search processing sequence according to the embodiment.

FIG. 7 is a diagram showing an example of input information in port search processing according to the embodiment.

FIG. 8 is a diagram showing an example of output information in port search processing according to the embodiment.

FIG. 9 is a diagram showing an example of a port search result according to the embodiment.

FIG. 10 is a diagram showing a port search processing command sequence according to the embodiment.

FIG. 11 is a diagram showing a volume search processing sequence according to the embodiment.

FIG. 12 is a diagram showing an example of input information in volume search processing according to the embodiment.

FIG. 13 is a diagram showing an example of output information in volume search processing according to the embodiment.

FIG. 14 is a diagram showing an example of a volume search result according to the embodiment.

FIG. 15 is a flowchart showing volume search processing according to the embodiment.

FIG. 16 is a diagram showing a volume search processing command sequence according to the embodiment.

FIG. 17 is a diagram showing an example of an external volume information table according to the embodiment.

FIG. 18 is a diagram showing an example of a device configuration report request command format according to the embodiment.

FIG. 19 is a diagram showing an example of a device configuration report request data format according to the embodiment.

FIG. 20 is a diagram showing an example of a number-of-devices report request command format according to the embodiment.

FIG. 21 is a diagram showing an example of a number-of-devices report response data format according to the embodiment.

FIG. 22 is a diagram showing an example of a device configuration acquisition request command format according to the embodiment.

FIG. 23 is a diagram showing an example of a device configuration acquisition response data format according to the embodiment.

FIG. 24 is a diagram showing an example of a device information format according to the embodiment.

FIG. 25 is a diagram showing an example of a device detailed information format according to the embodiment.

FIG. 26 is a diagram showing an example of an alternate path information format according to the embodiment.

FIG. 27 is a diagram showing an example of an intra-apparatus path information format according to the embodiment.

FIG. 28 is a diagram explaining the action of a storage system according to the embodiment.

FIG. 29 is a diagram showing an overall configuration for a storage system having two external storage apparatuses according to the embodiment.

FIG. 30 is a diagram showing an example of a device configuration report request command format according to a second embodiment of the invention.

FIG. 31 is a flowchart showing processing according to the embodiment.

FIG. 32 is a diagram explaining a storage system according to the embodiment.

### DETAILED DESCRIPTION OF PREFERRED EMBODIMENTS

### (1) First Embodiment

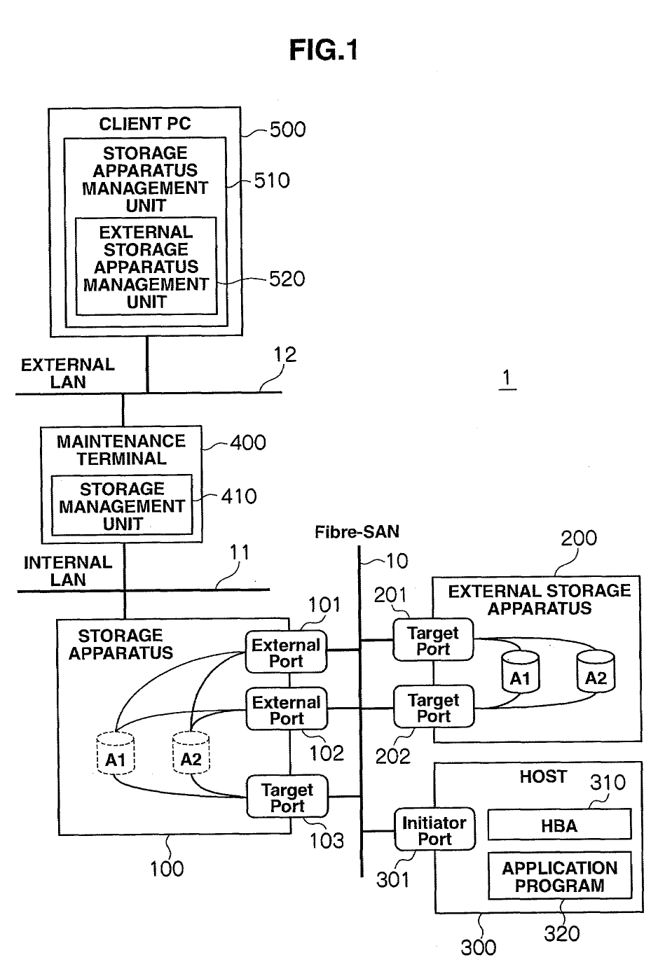

A first embodiment of the invention will be described. FIG. 1 is a diagram schematically showing an overall configuration for a storage system 1 in which the invention is utilized. As shown in FIG. 1, the storage system 1 includes a storage apparatus 100, an external storage apparatus 200, a host 300, a maintenance terminal 400, and a client PC (Personal Computer) 500.

The storage apparatus 100, the external storage apparatus 200, and the host 300 are connected to one another via a fibre cable 10, which forms Fibre-SAN (Storage Area Network). The storage apparatus 100 has external (external connection) ports 101 and 102 and a target port 103; the external storage apparatus 200 has target ports 201 and 202; and the host 300 has an initiator port 301. Incidentally, an initiator port is a communication port for having a host issue commands; a target port is a communication port for receiving and processing commands; and an external port is a kind of initiator port, and is used for connection with the external storage apparatus 200.

The storage apparatus 100 and the maintenance terminal 400 are connected via an internal LAN (Local Area Network) 11, and the maintenance terminal 400 is connected to the client PC 500 via an external LAN 12.

The host 300 is a computer device equipped with information processing resources such as a CPU (Central Processing Unit) and memory, and is composed of, e.g., a personal computer, work station, or main frame. The host 300 is provided with an HBA (Host Bus Adapter) 310 for having access to the storage apparatus 100 via the fibre cable 10 and an application program 320 such as database software. The host 300 requests data input/output with blocks serving as data management units for storage areas provided by plural disk drives in accordance with Fibre Channel Protocol.

The maintenance terminal 400 is a computer device for managing configuration, etc. for the storage system 1, and is operated by a user such as a system administrator. The maintenance terminal 400 is configured to include a storage management unit 410. The storage management unit 410 is composed of, e.g., software, and gives various instructions to the storage apparatus 100. According to the instructions, the control information, table, etc. in the storage apparatus 100 can be rewritten. Also, the maintenance terminal 400 acquires various kinds of information from the storage apparatus 100, and can display the information on its terminal screen.

The client PC 500 is a computer device for managing the entire storage system 1, and is operated by a user such as an system administrator, like the maintenance terminal 400. The client PC 500 is provided with a storage apparatus management unit 510 including an external storage apparatus management unit 520. The storage apparatus management unit 510 is composed of, e.g., software, and executes, for example, processing for navigating the operation by a user such as a system administrator. The client PC 500 also can display the information about the above processing on its display screen.

The first embodiment is described for the case where the maintenance terminal 400 and the client PC 500 are provided as separate devices. However, a configuration may be employed in which one of the devices includes a function of the other device.

The external storage apparatus management unit 520 conducts setting for connecting a logical volume in the external storage apparatus 200 as an external volume (virtual volume) for the storage apparatus 100 so that the host 300 can use the logical volume in the external storage apparatus 200 as the logical volume for the storage apparatus 100 according to the instructions from a user such as a system administrator. More specifically, the external storage apparatus management unit 520 acquires connection path information about relationships between an external port and a WWN (World Wide Name) and between a WWN and a LUN (Logical Unit Number) via a micro program in a control unit (e.g., a channel adapter 110 described later) in the storage apparatus 100, creates connection path information (port-WWN-LUN) for connecting the logical volume in the external storage apparatus 200 as the virtual volume in the storage apparatus 100 via Fibre-SAN, and sets the information in the control unit in the storage apparatus 100.

The connection path information is created based on “Inquiry” information for the logical volume in the external storage apparatus 200. The “Inquiry” information is obtained by the micro program in the control unit in the storage apparatus 100 issuing SCSI (Small Computer System Interface) commands to the target ports 201 and 202 in the external storage apparatus 200 via the external ports. Note that the details of the above processing, etc., will be specifically described later.

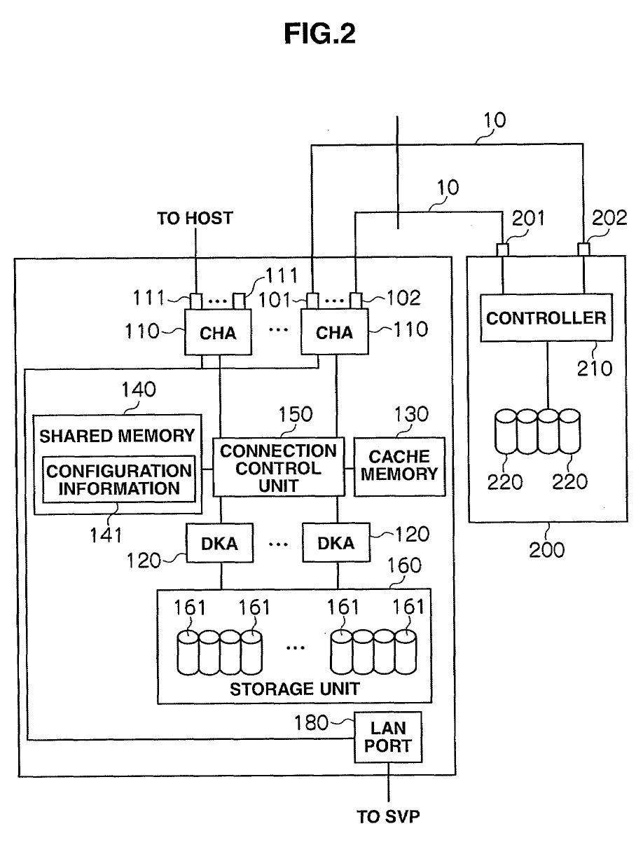

Next, the storage apparatus 100 and the external storage apparatus 200 will be explained with reference to FIG. 2. FIG. 2 is a diagram showing configurations for the storage apparatus 100 and the external storage apparatus 200.

The storage apparatus 100 is configured as, e.g., a disk array subsystem. As described above, the storage apparatus 100 provides the storage resources of the external storage apparatus 200 as its logical volume to the host 300. The storage apparatus 100 serves as a main storage apparatus in the storage system 1, and provides storage ability to the host 300. Meanwhile, the external storage apparatus 200 is an external storage apparatus used by the storage apparatus 100 serving as a main storage apparatus.

The storage apparatus 100 can be roughly divided into a controller and a storage unit 160. The controller can be configured to include, e.g., plural channel adapters (CHA) 110, plural disk adapters (DKA) 120, cache memory 130, shared memory 140, and a connection control unit 150.

Each of the channel adapters 110 conducts data communication with the host 300. Each channel adapter 110 is provided with ports 111 for communicating with the host 300. As described above, the ports 111 can be set as an initiator port, a target port, an external port, etc. Also, one of the channel adapters 110 has the external port 101 and 102 for communicating with the external storage apparatus 200.

Each channel adapter 110 is configured as a microcomputer system equipped with a CPU, memory, etc., and interprets various commands received from the host for execution. The channel adapter 110 is assigned a network address (e.g., IP address or WWN) for identification, can function as individual NAS (Network Attached Storage). When plural hosts 300 exist, the channel adapter 110 receives a request from each of the hosts 300 for processing.

Each of the disk adapters 120 conducts data transfer with disk drives 161 in the storage unit 160. The disk adapter 120 is configured as a microcomputer system equipped with a CPU, memory, etc., like the channel adapter 110. The disk adapter 120 writes, e.g., the data the channel adapter 110 has received from the host 300 or the data read from the external storage apparatus 200 to a predetermined address in a predetermined one of the disk drives 161.

Each disk adapter 120 also reads data from a predetermined address in a predetermined one of the disk drives 161, and sends the data to the host 300 or the external storage apparatus 200. When conducting data input/output with the disk drive 161, the disk adapter 120 converts a logical address into a physical address. When the disk drives 161 are managed according to RAID (Redundant Arrays of Independent/Inexpensive Disks), the disk adapter 120 conducts data access based on a RAID configuration. For example, the disk adapter 120 writes the same data to separate disk drives constituting a group (RAID group), or executes parity calculation and writes data and parity to the disk drive group.

The cache memory 130 stores the data received from the host 300 or the external storage apparatus 200, and stores the data read from the disk drive 161.

The shared memory 140 stores various kinds of control information and configuration information 141, etc. used for controlling the operation of the storage apparatus 100. In the maintenance terminal 400, all or part of the configuration information stored in the shared memory 140 can be rewritten.

Incidentally, one or more of the disk drives 161 may be used as a cache disk(s). The cache memory 130 and the shared memory 140 may be configured as separate memories. Alternatively, a configuration may be adopted where a part of a storage area in memory is used as a cache area, while the rest of the storage area is used as a control area.

The connection control unit 150 establishes mutual connection between the channel adapters 110, the disk adapters 120, the cache memory 130, and the shared memory 140. The connection control unit 150 can be configured as a high-speed bus such as an ultrahigh-speed cross bus switch for conducting data transfer via high-speed switching.

The storage unit 160 is provided with the disk drives 161. Examples of the disk drives 161 include various storage devices such as a hard disk drive, flexible disk drive, magnetic tape drive, semiconductor memory drive, and optical disk drive, and equivalents thereof. Also, a different kind of disk such as an FC. (Fibre Channel) disk or SATA (Serial AT Attachment) disk can be used together with the storage devices in the storage unit 160.

Note that, as will be described later, a virtual volume 163V, which is based on disk drives 220 in the external storage apparatus 200, is formed in the storage apparatus 100. The virtual volume 163V is provided to the host 300, like internal volumes 163 based on the disk drives 161.

The external storage apparatus 200 can be configured to include, e.g., a controller 210 and the plural disk drives 220. The controller 210 controls the entire operation of the external storage apparatus 200. The external storage apparatus 200 is connected to the storage apparatus 100 via the ports 201 and 202.

The external storage apparatus 200 can be configured in substantially the same way as the storage apparatus 100, and can be configured to have a configuration different from that of the storage apparatus 100. Each of the disk drives 220 in the external storage apparatus 200 is treated as an internal storage device in the storage apparatus 100.

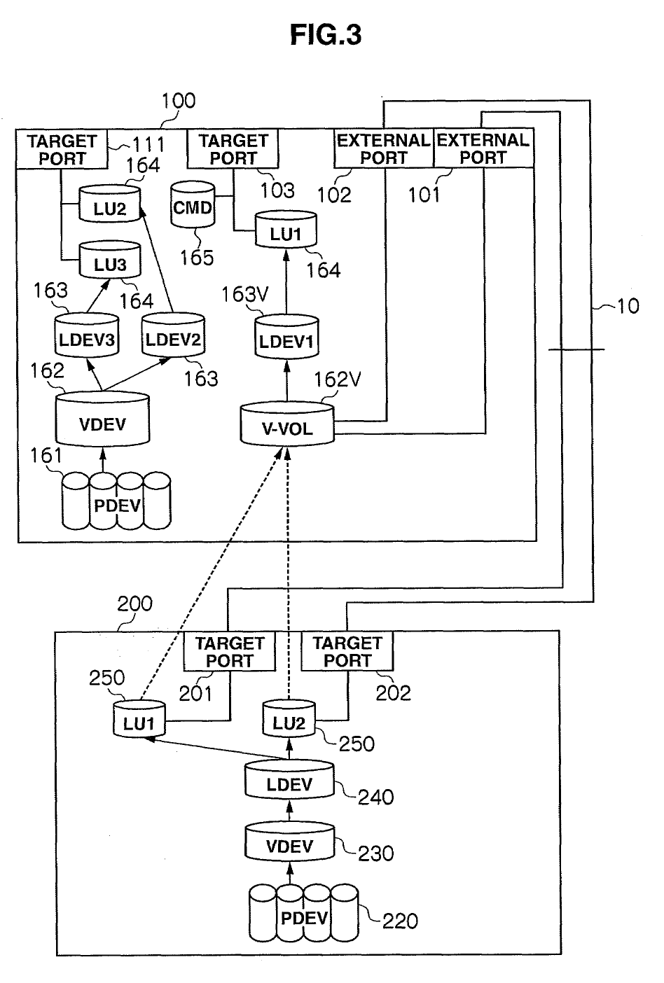

Next, a configuration focused on logical storage structures of the storage apparatus 100 and the external storage apparatus 200 will be explained. FIG. 3 is a diagram showing the logical storage structures of the storage apparatus 100 and the external storage apparatus 200. The structure of the storage apparatus 100 will be explained first.

The storage structure of the storage apparatus 100 can be roughly divided into, e.g., a physical storage hierarchy and a logical storage hierarchy. The physical storage hierarchy is composed of the physical disk PDEVs (Physical Devices) 161. The PDEVs correspond to the disk drives.

The logical storage hierarchy can be composed of plural (e.g. two kinds of) hierarchies. One of the logical hierarchies can be composed of a VDEV (Virtual Device) 162 and a VDEV (hereinafter, also referred to as “V-VOL”) 162V, that is treated like the VDEV 162. The other logical hierarchy can be composed of the LDEVs (Logical Devices) 163.

The VDEV 162 is formed by grouping a predetermined number of the PDEVs 161, e.g., four pieces (3D+1P) or eight pieces (7D+1P) for one group. The aggregate of the storage areas provided by the PDEVs 161 belonging to a group forms a RAID storage area. The RAID storage area corresponds to the VDEV 162.

In contrast to the VDEV 162 constructed on the physical storage areas, the V-VOL 162V is a virtual intermediate storage device that does not directly require a physical storage area. The V-VOL 162V is not made to directly correspond to the physical storage area, and undertakes mapping of LUs (Logical Units) in the external storage apparatus 200.

At least one LDEV 163 can be provided above each of the VDEV 162 and the V-VOL 162V. An LDEV is a logical volume. The LDEV 163 can be configured by, e.g., dividing the VDEV 162 into units of a fixed length. Note that the LDEV set on the V-VOL 162 is given the reference symbol of “163V” in FIG. 3, but is referred to as LDEV 163 irrespective of the derivation, for example, when no distinction is required.

When the host 300 is an open system host, the LDEVs 163 are respectively mapped to LUs 164, so that the host 300 recognizes each LDEV 163 as a physical disk. The open system host accesses a desired LDEV 163 by specifying a LUN or logical block address.

The LUs 164 are devices recognizable as SCSI logical units. Each of the LUs 164 is connectable to the host 300 via the target port 111. At least one of the LDEVs 163 can be made to correspond to each of the LUs 164. Note that, the LU size can be virtually expanded by making plural LDEVs 163 correspond to one LU 164.

A CMD (Command Device) 165 is an LU exclusively used for the transfer of a command or status between an 1/0 control program that operates on the host 300 and the controller (channel adapter 110, disk adapter 12, etc.) in the storage apparatus 100. For example, the host 300 can write a command to the CMD 165. The controller in the storage apparatus 100 executes processing in accordance with the command written to the CMD 165, and writes the execution result serving as a status to the CMD 165. The host 300 reads the status written to the CMD 165 for confirmation, and writes the content of processing to be executed next to the CMD 165. In this way, the host 300 can give various instructions to the storage apparatus 100 via the CMD 165.

Incidentally, the command received from the host 300 can be processed without being stored in the CMD 165. Also, the CMD 165 may be created as a virtual device while not defining the relevant actual device (LU), and may be configured to receive and process a command from the host 300. More specifically, for example, the channel adapter 110 writes the command received from the host 300 to the shared memory 140, and the channel adapter 110 or the disk adapter 120 processes the command stored in the shared memory 140. The processing result is written to the shared memory 140, and then is sent to the host 300 from the channel adapter 110.

The storage apparatus 100 is provided with the external ports 101 and 102. The external ports 101 and 102 are respectively connected to the target ports 201 and 202 in the external storage apparatus 200 via the fibre cable 10. The external ports 101 and 102 are connected to the V-VOL 162V. The V-VOL 162V is connected to the external storage apparatus 200 via plural paths.

The external storage apparatus 200 can be configured to include, e.g., plural PDEVs 220, a VDEV 230 set above the storage areas provided by the PDEVs 220, and at least one LDEV 240V settable above the VDEV 230. Each LDEV 240 is made to correspond to LUs 250. Also, the LUs 250 are made to correspond to the target ports 201 and 202, respectively.

The LUs 250 in the external storage apparatus 200 are connected to the common LDEV 240. The LUs 250 also are connected to the respective external port 101 and 102 via the port 201 and 202 through the communication line. As described above, the external ports 101 and 102 are connected to the common V-VOL 162V.

Therefore, the LDEV 240 in the external storage apparatus 200 is made to correspond to the V-VOL 162V via the plural paths. As a result, the LDEV 240, which serves as a storage resource for the storage apparatus 100, in the external storage apparatus 200 is available as an external volume via the paths. One pair of the V-VOL 162V and the LDEV 240 is shown in FIG. 3, but other pairs of V-VOLs 162V and LDEVs 240 may be provided.

In the storage apparatus 100, “LDEV 2” and LDEV 3” correspond to actual internal volumes, and “LDEV 1” corresponds to a virtual volume. “LDEV” in the external storage apparatus 200 corresponds to an actual volume. Note that, where a central focus is put on the storage apparatus 100, the external storage apparatus 200 serves as an external storage apparatus, and the logical volume 240 in the external storage apparatus 200 serves as an external volume.

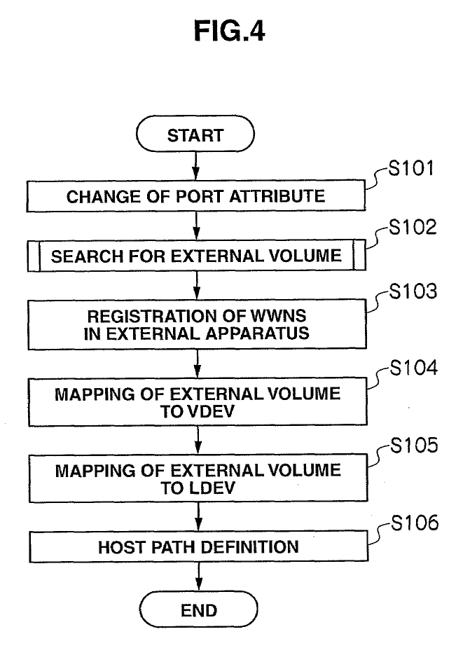

Explained next is a procedure executed by a user such as a system administrator for searching for connection paths for access to an external volume, which has become not-connectable because of a fault due to the reason of, e.g., the occurrence of a fault in a path in the storage system 1 configured as describe above, via another path; and setting the external volume to a usable state. FIG. 4 is a flowchart showing the above procedure. The procedure is executed by a user operating the client PC 500. Note that the first embodiment is described for the case where an external volume is set when a fault occurs in a path. However, the same procedure applies also to the case where an external volume is set at a given time, such as when an initial setting for the host 300 is made or when paths are rearranged.

A user conducts port management in step S101. More specifically, the user instructs the storage apparatus management unit 510 in the client PC 500 to conduct port attribute change. The port attribute change is a procedure for changing the attribute for the port in the storage apparatus 100 to an external attribute indicating the usage via external connection.

In step S102, a user instructs the external storage apparatus management unit 520 in the storage apparatus management unit 510 to search for an external volume. According to the instruction, the external storage apparatus management unit 520 executes port search processing and volume search processing to search for connection paths to the volume in the external storage apparatus 200. The details of the port search processing and volume search processing will be described in volume search processing described later.

In step S103, a user instructs the external storage apparatus management unit 520 to register WWNs in the external storage apparatus 200. According to this instruction, the external storage apparatus management unit 520 registers the WWNs in the external storage apparatus 200 that are used as connection paths to the external volume in the configuration information 141 in the storage apparatus 100.

In step S104, a user instructs the external storage apparatus management unit 520 to conduct mapping of the external volume to the VDEV. According to those instructions, the external storage apparatus management unit 520 defines the external volume as a virtual volume in the configuration information 141 in the storage apparatus 100 in order to make the external volume able to be treated like a volume in the storage apparatus 100.

In step S105, a user instructs the external storage apparatus management unit 520 to conduct mapping of the external volume to the LDEV. According to those instructions, the external storage apparatus management unit 520 defines the VDEV as a logical volume recognized by the host 300 in the configuration information 141 in the storage apparatus 100.

In step S106, a user conducts LUN management. More specifically, the user instructs the storage apparatus management unit 510 in the client PC 500 to conduct host path definition. The host path definition is processing for defining, in the LDEV, the connection paths (target port-host group-LU) recognized by the host 300.

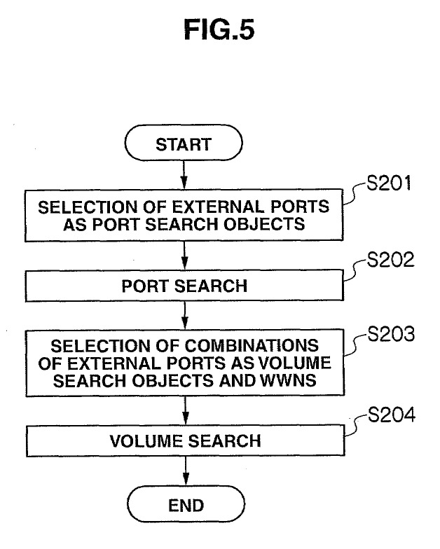

The external volume is set with other connection paths by executing the above processing, and so can be used as an external volume by the host 300. Hereinafter, volume search processing for an external volume will be described. FIG. 5 is a flowchart showing external volume search processing executed by the external storage apparatus management unit 520.

In step S201, the external storage apparatus management unit 520 selects external ports as port search objects. In step S202, the external storage apparatus management unit 520 executes port search processing. This port search processing will be specifically described later. After the port search processing is executed, in step S203, the external storage apparatus management unit 520 selects combinations, which serve as volume search objects, of external ports and WWNs. In step S204, the external storage apparatus management unit 520 executes volume search processing. This volume search processing will be specifically described later.

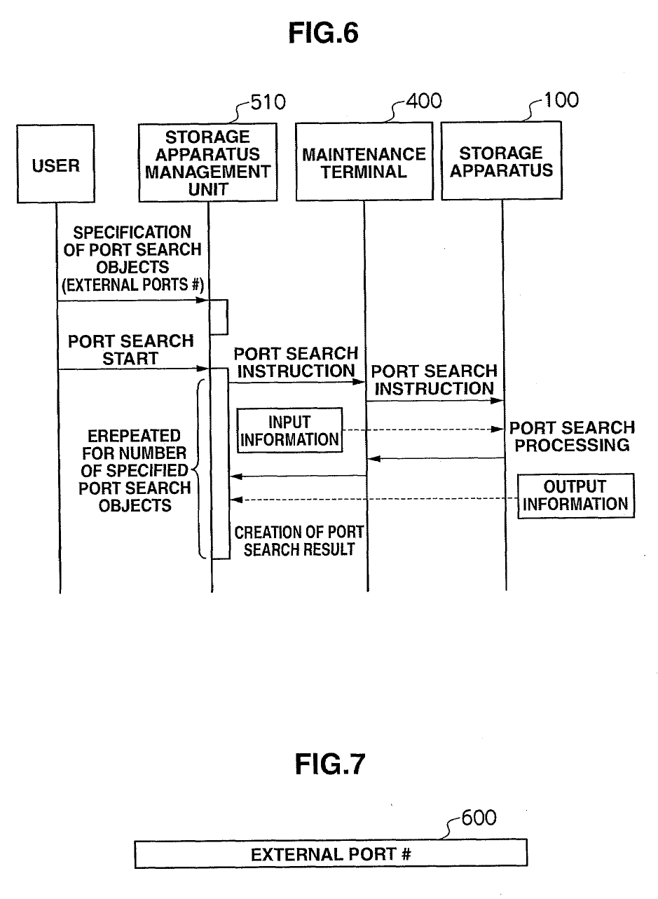

The specific contents of port search processing and volume search processing will be explained using FIGS. 6 to 10 and FIGS. 11 to 16, respectively. First, port search processing will be explained.

FIG. 6 is a diagram showing a port search processing sequence. A user specifies plural external ports that the user wants to subject to a port search, and issues an instruction to start the search. The storage apparatus management unit 510 specifies one of the external ports as input information, and instructs the maintenance terminal 400 to start the port search. The maintenance terminal 400 sends the input information to the storage apparatus 100, and instructs the storage apparatus 100 to conduct the port search. The storage apparatus 100 implements a port search processing command sequence on the external port specified as the input information, and sends output information as a port search result to the maintenance terminal 400. The maintenance terminal 400 sends the output information as the port research result to the storage apparatus management unit 510. The storage apparatus management unit 510 creates a port search result based on the output information. The above processing is repeated for the external ports specified by a user.

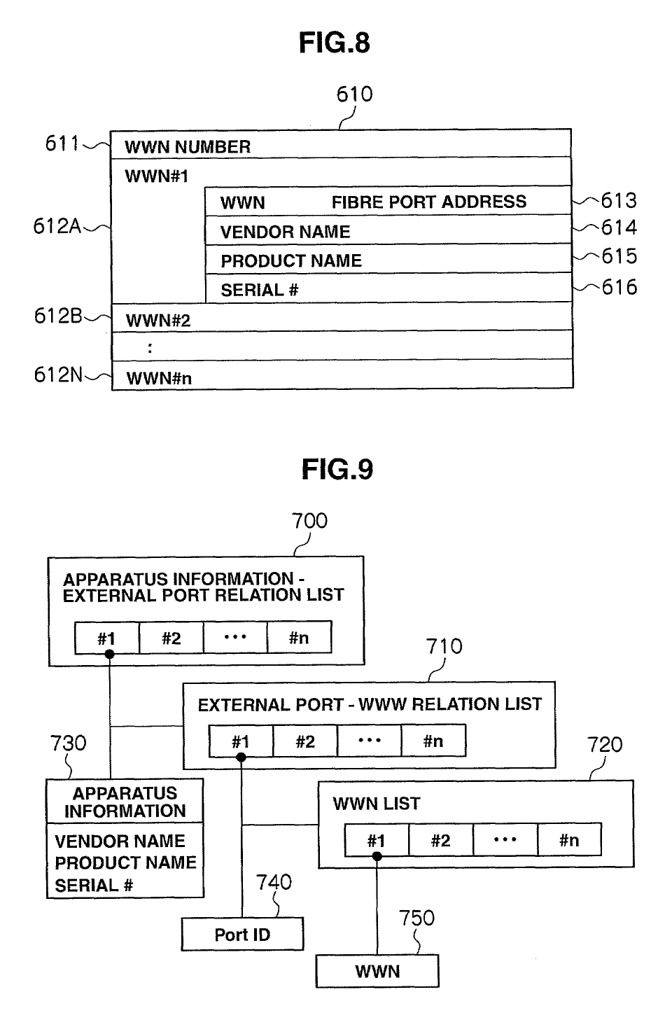

FIG. 7 is a diagram showing an example of input information 600 in port search processing. FIG. 8 is a diagram showing an example of output information 610 in port search processing. The output information 610 includes the number of WWNs 611 and WWN numbers 612A to 612N. The WWN number 612A includes a WWN fibre port address 613, a vendor name 614, a product name 615, and a serial number 616. Note that, although not shown in the figure, the WWN numbers 612B to 612N each include the WWN fibre port address 613, the vendor name 614, the product name 615, and the serial number 616.

FIG. 9 is a diagram showing an example of a port search result. Apparatus information 730 is composed of the vendor name, product name, and serial number in the output information 610. An apparatus information−external port relation list 700 stores the list of numbers for external ports that detect the relevant apparatus with the apparatus information 730 as a key. An external port−WWN relation list 710 stores the WWN information obtained as a result of the port search for the relevant external ports with, as a key, a port ID 740 for the external port on which the port search has been conducted. A user selects an apparatus as a volume search object, an external port as a connection object, and a WWN for an external apparatus based on the port search result, and instructs the external storage apparatus management unit 520 to conduct a volume search.

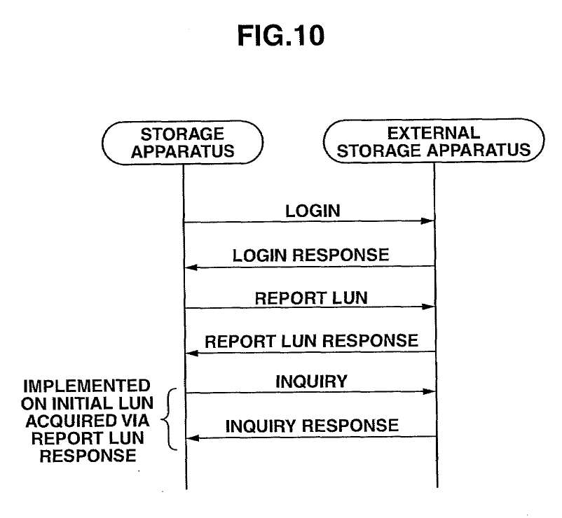

FIG. 10 is a diagram showing a port search processing command sequence. This port search processing command sequence is performed between the storage apparatus 100 and the external storage apparatus 200. When the storage apparatus 100 logs in with the external storage apparatus 200, the external storage apparatus 200 issues a login response to the storage apparatus 100. When the storage apparatus 100 sends a “Report LUN” command to the external storage apparatus 200, the external storage apparatus 200 issues a response to the command to the storage apparatus 100. Then, when the storage apparatus 100 sends an “Inquiry” command to the external storage apparatus 200, the external storage apparatus 200 issues a response to the command to the storage apparatus 100.

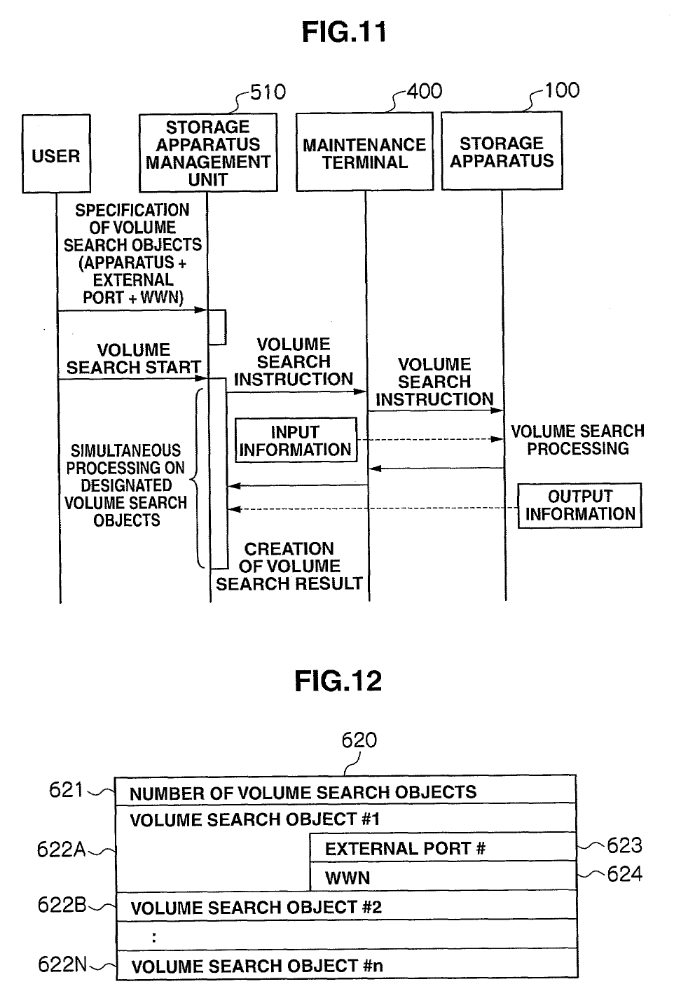

Volume search processing will be explained next. FIG. 11 is a diagram showing a volume search processing sequence. A user specifies, as input information, plural combinations of external ports as volume search objects and WWNs based on the port search result, as described above, and instructs the storage apparatus management unit 510 to start a volume search. The storage apparatus management unit 510 sets all the combinations of external ports and WWNs specified as the input information, and instructs the maintenance terminal 400 to start the volume search. The maintenance terminal 400 sends the input information to the storage apparatus 100, and instructs the storage apparatus 100 to conduct the volume search. The storage apparatus 100 executes the volume search processing command sequence on the external ports specified as the input information through the target ports indicated by WWNs in the external storage apparatus 200, creates output information as a volume search result, and sends the result to the maintenance terminal 400. The maintenance terminal 400 sends the output information as the port search result to the storage apparatus management unit 510. The storage apparatus management unit 510 creates a volume search result based on the output information.

FIG. 12 is a diagram showing an example of input information 620 in volume search processing. The input information 620 includes the number of volume search objects 621 and volume search objects 622A to 622N. The volume search object 622A includes an external port number 623 and a WWN 624. Note that, although not shown in the figure, the volume search objects 622B to 622N each also include the external port number 623 and the WWN 624.

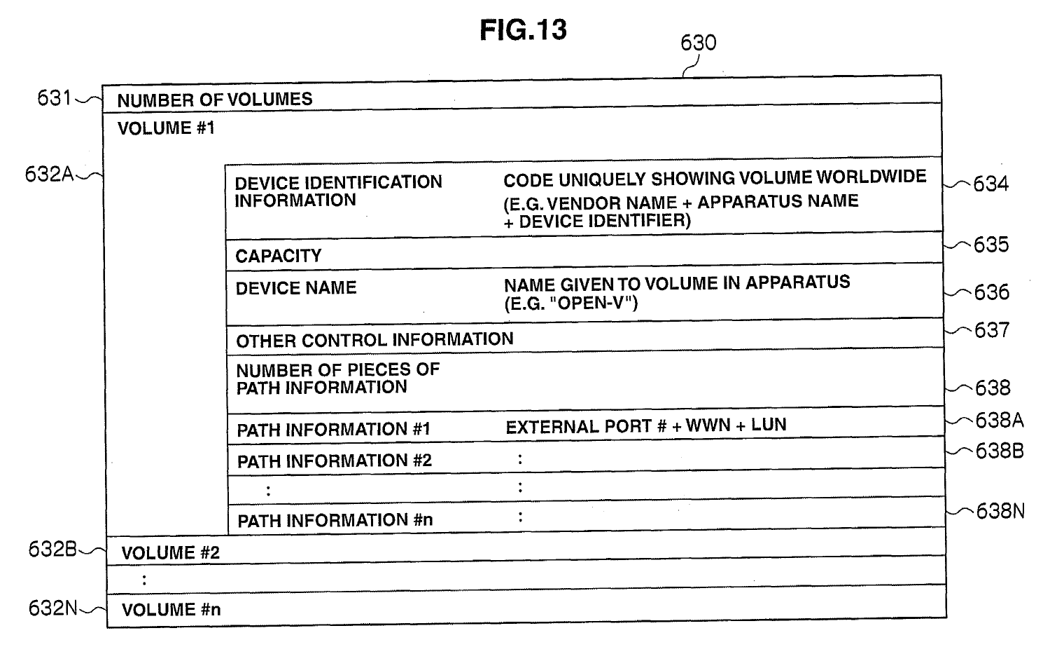

FIG. 13 is a diagram showing an example of output information 630 in volume search processing. The output information 630 includes volume numbers 1 to N (632A to 632N). The volume number 632A includes device identification information 634, a capacity 635, a device name 636, other control information 637, number of pieces of path information 638, and path information 638A to 638N. The device identification information 634 is a code uniquely showing a volume world wide (e.g., vendor name+apparatus name+device identifier). The capacity 635 is a volume capacity. The device name 636 is a name, which is given to a volume in the apparatus, such as “OPEN-V.” The other control information 637 is information including, e.g., alternate path information. The number of pieces of path information 638 is the number of pieces of information about paths connected to the relevant volume. The path information 638A to 638N each show the content of a path connected to the relevant volume, and specifically indicate external port number+WWN+LUN. Note that, although not shown in the figure, the volume 632B to 632N each also include the device identification information 634, the capacity 635, the device name 636, the other control information 637, the number of pieces of path information 638, and the path information 638A to 638N.

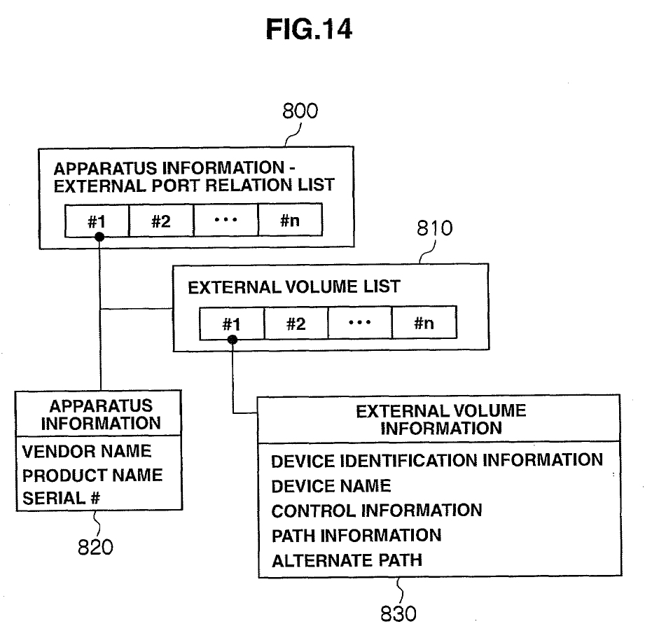

FIG. 14 is a diagram showing an example of a volume search result. An apparatus information−external port relation list 800 stores the list of the external port numbers that detect the relevant apparatus with information 820 included in the output information 630 as a key. An external volume list 810 stores external volume information 830 for external volume numbers. The external volume information 830 is composed of the device identification information 634, the capacity 635, the device name 636, the control information 637 about alternate paths, etc, and the path information 638A to 638N included in the output information 630. Also, the external volume information 830 is created as a volume search result by the storage apparatus management unit 510 based on the output information 630. The external volume list 810 for the apparatus as a search object is created by the storage apparatus management unit 510.

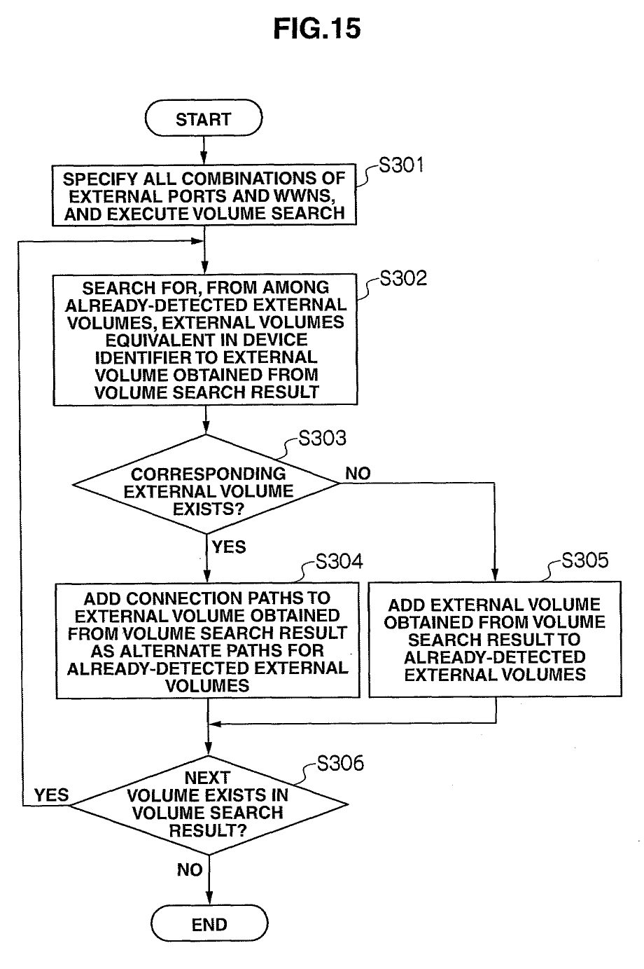

FIG. 15 is a flowchart showing volume search processing. This processing is executed by the control unit (e.g., channel adapter 110) in the storage apparatus 100.

First, in step S301, the control unit specifies all the combinations of external ports and WWNs specified as the input information, and conducts a volume search. In step S302, the control unit searches for, from among the already-detected external volumes, the external volumes equivalent in the device identification information 634 to the external volume obtained from the volume search result. In step S303, the control unit judges whether or not a corresponding external volume exists. If it is determined that a corresponding external volume exists (S303: YES), the control unit adds connection paths to the external volume obtained from the volume search result as alternate paths for the already-detected external volumes in step S304. Meanwhile, if it is determined that a corresponding external volume does not exist (S303: NO), the control unit adds the external volume obtained from the volume search result to the already-detected external volumes in step S305.

When the step S304 or step S305 terminates, the control unit judges whether or not the next volume exists in the volume search result in step S306. If it is determined that the next volume exists (S306: YES), the control unit executes steps S302 to S306 again. Meanwhile, if it is determined that the next volume does not exist (S306: NO), the control unit terminates processing.

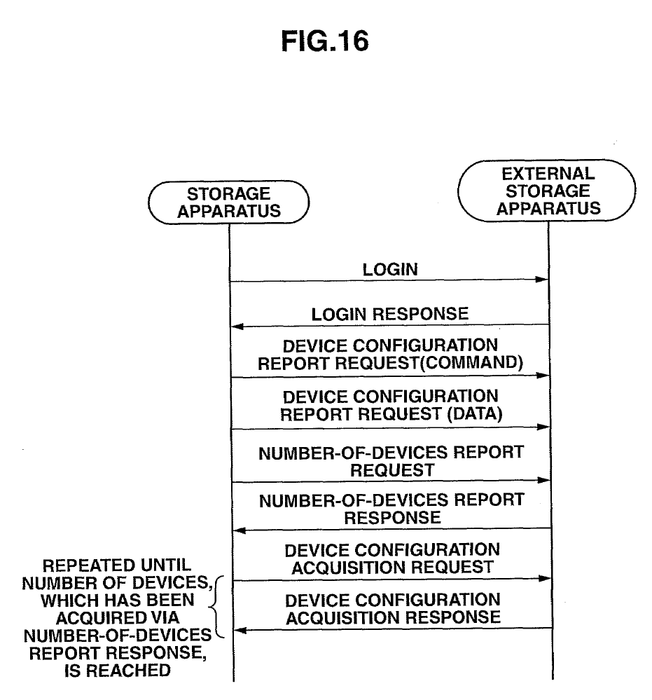

FIG. 16 is a diagram showing a volume search processing command sequence. The volume search processing command sequence is performed between the storage apparatus 100 and the external storage apparatus 200. When the storage apparatus 100 logs in with the external storage apparatus 200, the external storage apparatus 200 issues a login response to the storage apparatus 100. Then, the storage apparatus 100 sends a device configuration report request command to the external storage apparatus 200. The storage apparatus 100 sends device configuration report request data to the external storage apparatus 200. Subsequently, the storage apparatus 100 sends a number-of-devices report request to the external storage apparatus 200. Then, the external storage apparatus 200 reports, as a response, the number of devices to the storage apparatus 100. After that, the storage apparatus 100 issues a device configuration acquisition request to the external storage apparatus 200, and acquires the response from the external storage apparatus 200. The issue of the device configuration acquisition request and the following acquisition are repeated until the number of devices, which has been acquired via the number-of-devices report response, is reached.

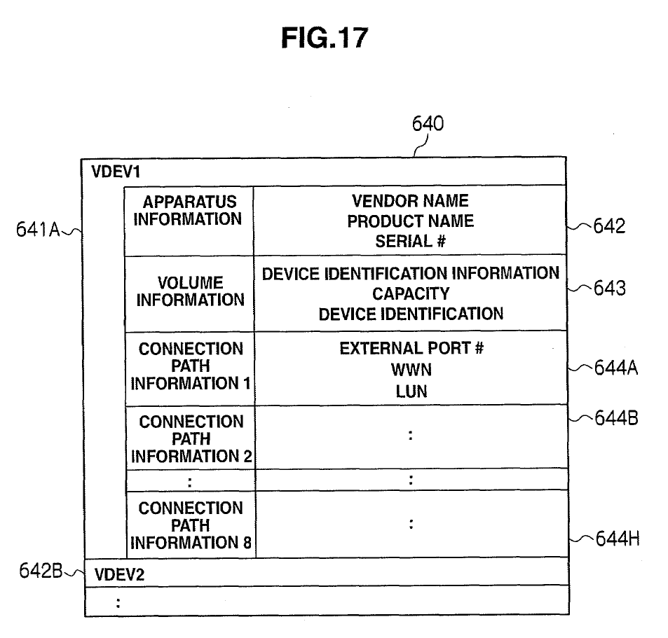

FIG. 17 is a diagram showing an example of an external volume information table 640. The external volume information table 640 is created by a user selecting the external volumes as VDEV mapping objects and the paths connected to the external volumes based on the volume search result described with reference to FIG. 14.

As shown in FIG. 17, the external volume information table 640 includes a VDEV 641A, a VDEV 641B, . . . . The VDEV 641A, VDEV 641B, . . . , each include apparatus information 642, volume information 643, and connection path information 1 to 8 (644A to 644H). The apparatus information 642 includes a vendor name, product name, and serial number. The volume information 643 includes device identification information, capacity, and device kind. The connection path information 644A to 644H each include an external port number, WWN, and LUN.

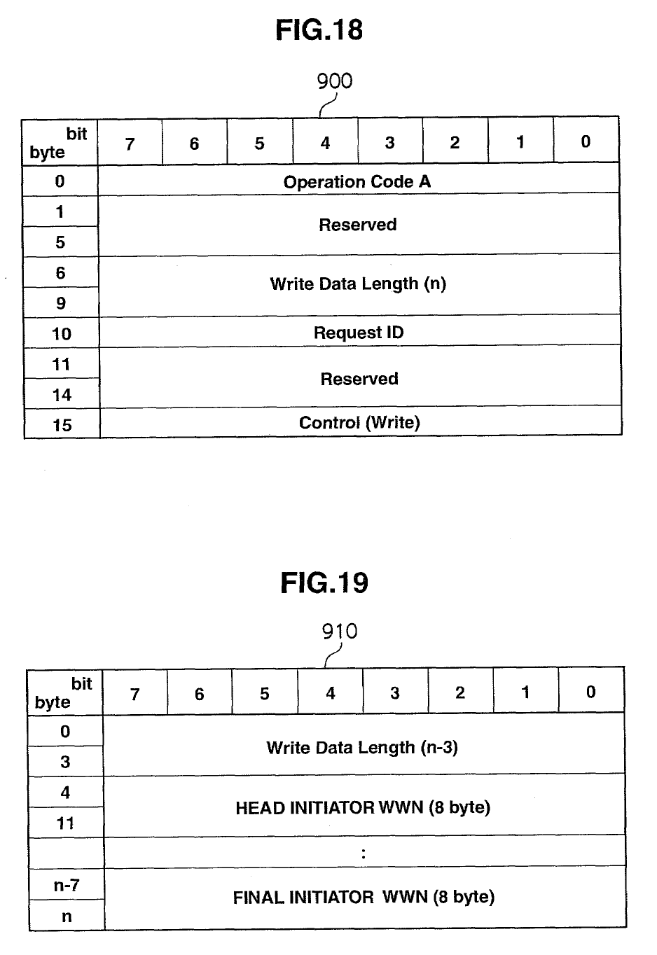

Next, a specific example of the command format used in the volume search processing command sequence described with reference to FIG. 16 will be explained with reference to FIGS. 18 and 27.

FIG. 18 is a diagram showing an example of a device configuration report request command format 900. The device configuration report request command format 900 includes “Operation Code A,” “Reserved,” “Write Data Length,” “Request ID,” “Reserved,” and “Control (Write)” areas. Note that “Operation Code A” is an operation code with which a device configuration report request is preset.

FIG. 19 is a diagram showing an example of a device configuration report request data format 910. The device configuration report request data format 910 includes “Write Data Length,” “Head Initiator WWN,” . . . , and “Final Initiator WWN” areas.

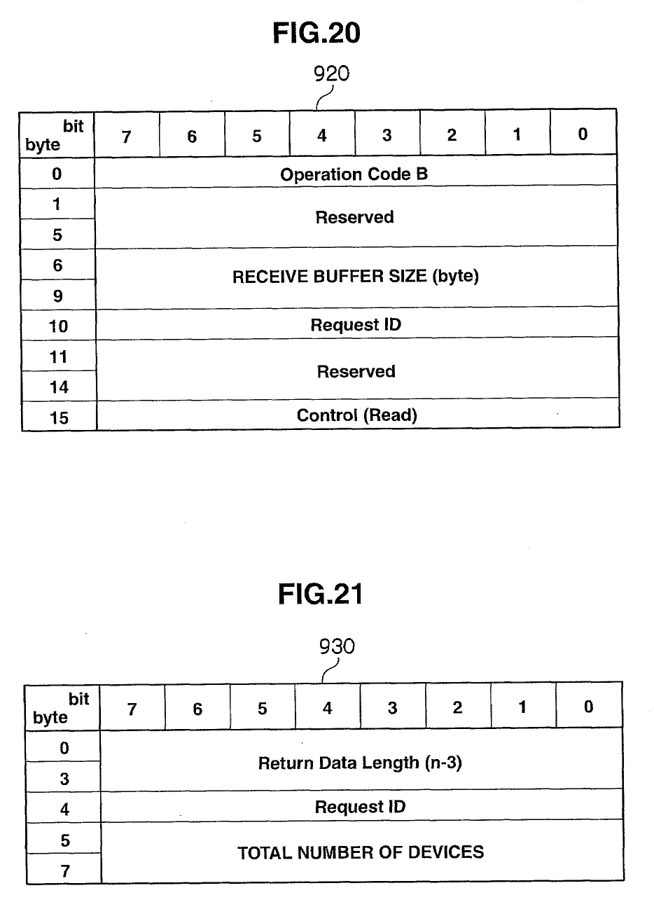

FIG. 20 is a diagram showing an example of a number-of-devices report request command format 920. The number-of-devices report request command format 920 includes “Operation Code B,” “Reserved,” “Receive Buffer Size,” “Request ID,” “Reserved,” “Control(Read)” areas. Note that “Operation Code B” is an operation code with which a number-of-devices report request is preset.

FIG. 21 is a diagram showing an example of a number-of-devices report response data format 930. The number-of-devices report response data format 930 includes “Return Data Length,” “Request ID,” and “Total Number of Devices” areas.

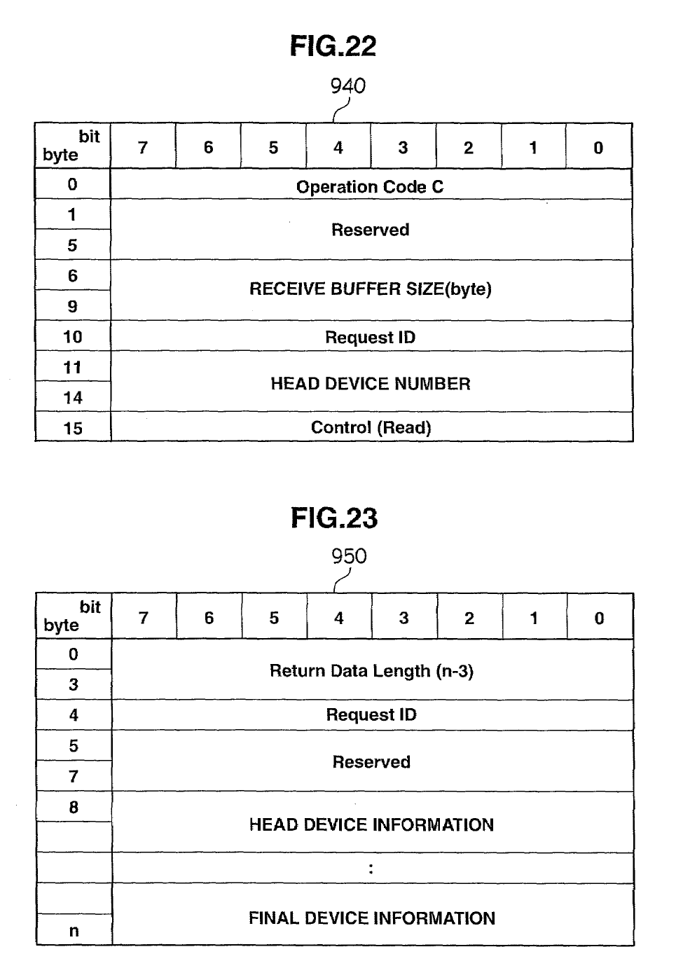

FIG. 22 is a diagram showing an example of a device configuration acquisition request command format 940. The device configuration acquisition request command format 940 includes “Operation Code C,” “Reserved,” “Receive Buffer Size,” “Request ID,” “Head Device Number,” and “Control (Read)” areas. Note that “Operation Code C” is an operation code with which a device configuration acquisition request is preset.

FIG. 23 is a diagram showing an example of a device configuration acquisition response data format 950. The device configuration acquisition response data format 950 includes “Return Data Length,” “Request ID,” “Reserved,” “Head Device Information.” . . . , and “Final Device Information” areas.

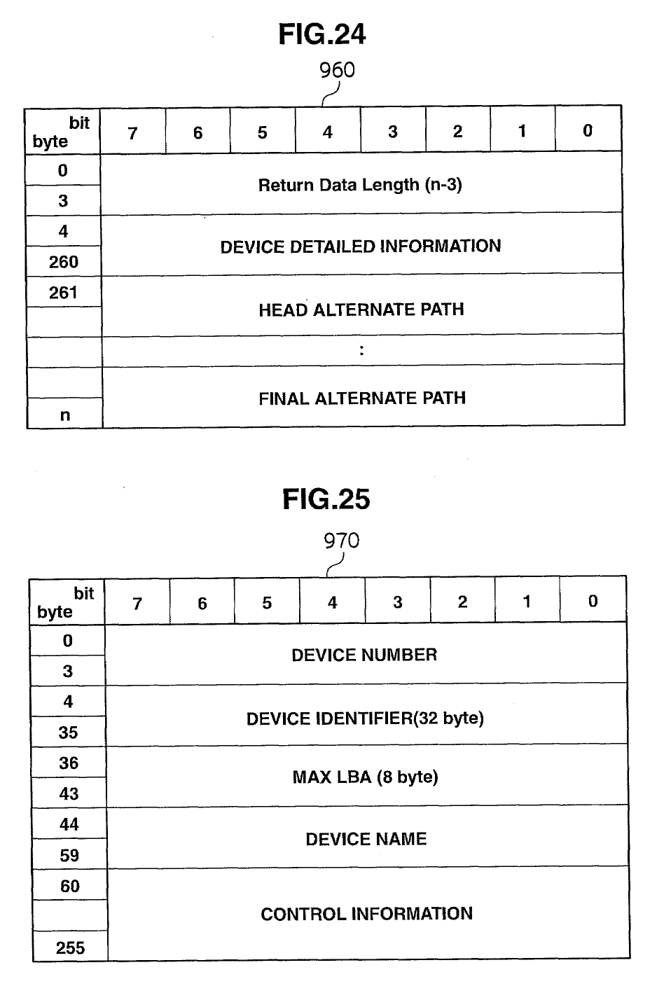

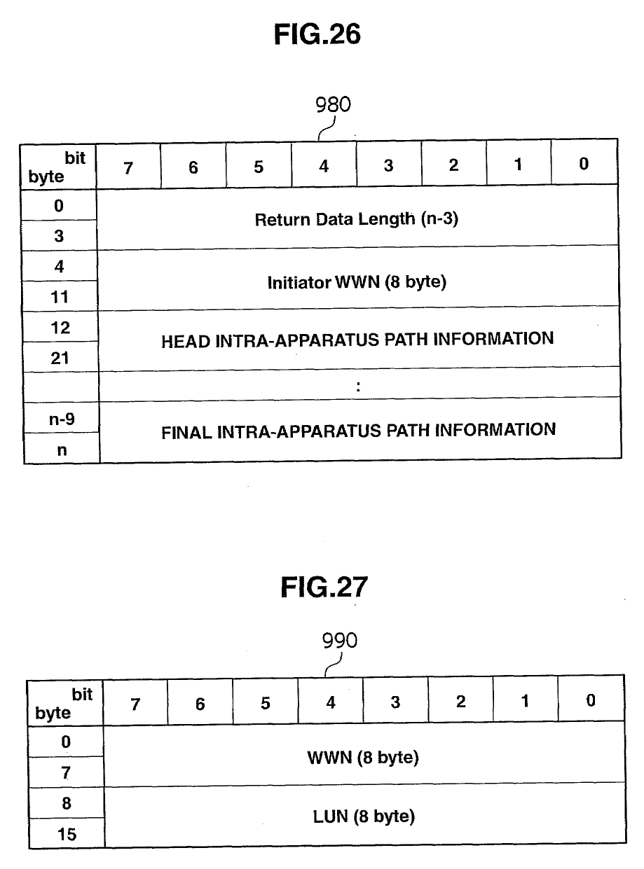

FIG. 24 is a diagram showing an example of a device information format 960. The device information format 960 includes “Return Data Length,” “Device Detailed Information,” “Head Alternate Path,” . . . , “Final Alternate Path” areas. “Device Detailed Information,” “Head Alternate Path,” . . . , and “Final Alternate Path” will be explained further in detail with reference to FIGS. 25 and 26.

FIG. 25 is a diagram showing an example of a device detailed information format 970. The device detailed information format 970 includes “Device Number,” “Device Identification Information,” “MAX LBA (Device Capacity),” “Device Name,” and “Control Information” areas.

FIG. 26 is a diagram showing an example of an alternate path information format 980. The alternate path information format 980 includes “Return Data Length,” “Initiator WWN,” “Head Intra-Apparatus Path Information,” . . . , and “Final Intra-Apparatus Path Information” areas. Note that “Head Intra-Apparatus Path Information,” . . . , and “Final Intra-Apparatus Path Information” will be explained further in detail with reference to FIG. 27.

FIG. 27 is a diagram showing an example of an intra-apparatus path information format 990 stored in each of the “Head Intra-Apparatus Path Information,” . . . , and “Final Intra-Apparatus Path Information” areas. The intra-apparatus path information format 990 includes “WWN” and “LUN” areas.

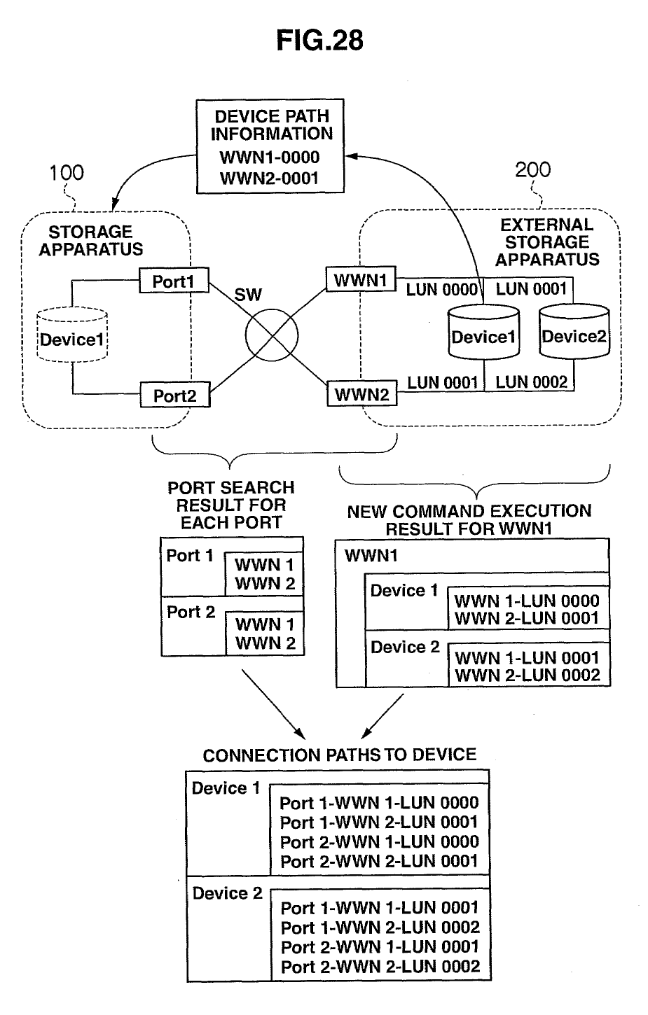

Next, the action of the storage system 1 will be explained. FIG. 28 is a diagram explaining the action of the storage system 1.

In the storage system 1 shown in FIG. 28, actual device 1 and actual device 2 are provided, in the external storage apparatus 200, as external volumes corresponding to virtual device (virtual volume) 1 provided in the storage apparatus 100. The storage apparatus 100 includes ports 1 and 2 as external ports, and is connected to actual devices 1 and 2 in the external storage apparatus 200 via WWN 1 and WWN 2 in the external storage apparatus 200. Specifically, connection to actual device 1 in the external storage apparatus 200 can be established via WWN 1 with LUN 0000, and can be established via WWN 2 with LUN 0001. Connection to actual device 2 in the external storage apparatus 200 is established via WWN 1 with LUN 0001, and can be established via WWN 2 with LUN 0002.

With the above configuration, when a port search for ports 1 and 2 is performed, WWN 1 and WWN 2 are found for port 1, and WWN 1 and WWN 2 are found for port 2. Then, when the volume search, which has been described with reference to FIG. 16, is conducted, the information about the paths to actual devices 1 and 2 via WWN 1 is sent from the external storage apparatus 200 to the storage apparatus 100. The sent information about the paths to actual device 1 includes WWN 1-LUN 0000 and WWN 2-LUN 0001. The sent information about the paths to actual device 2 includes WWN 1-LUN 0001 and WWN 2-LUN 0002.

Therefore, the storage apparatus 100 can acquire information about connection paths to external volumes based on the search result for each port and the volume search result for WWN 1. More specifically, only by performing the volume search for WWN 1 after the port search can the storage apparatus 100 acquire the information that there are four connection paths for actual device 1, i.e., port 1-WWN 1-LUN 0000, port 1-WWN 2-LUN 0001, port 2-WWN 1-LUN 0000, and port 2-WWN 2-LUN 0001; and there are four connection paths for actual device 2, i.e., port 1-WWN 1-LUN 0001, port 1-WWN 2-LUN 0002, port 2-WWN 1-LUN 0001, and port 2-WWN 2-LUN 0002.

The volume information possible to be acquired in conventional volume searches has included only the LUNs connected to the WWN for which the search was conducted. Therefore, a search for different WWNs has been required to search for external volumes having the corresponding device identification information for acquiring other paths. However, the storage system 1 enables acquisition of the connection information (combinations of WWNs and LUNs) in the external storage apparatus 200, leading to acquisition of all the connection paths.

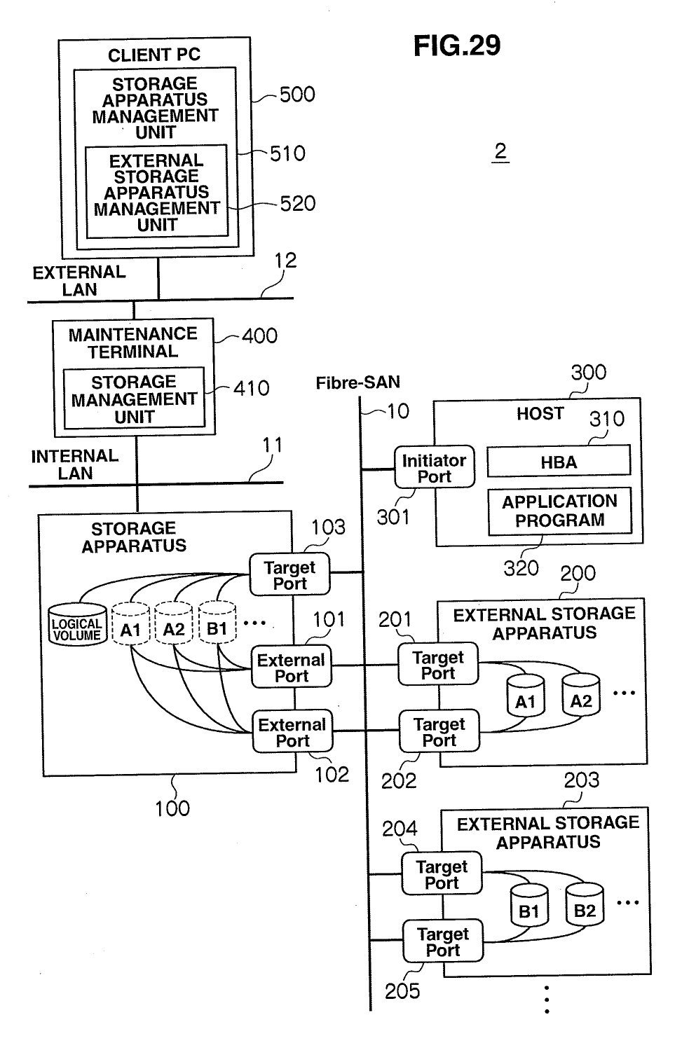

Incidentally, the first embodiment has been described for the case where the external storage apparatus 200 is provided as an external storage apparatus. However, a storage system in which not only the external storage apparatus 200 but also an external storage 203 is connected to the fibre cable 10 can be utilized in the present invention. FIG. 29 is a diagram showing an overall configuration for a storage system 2 having external storage apparatuses 200 and 203. Note that this second embodiment is described for the case where the external storage apparatuses 200 and 203 are provided as external storage apparatuses, but three or more external storage apparatuses may be provided.

### (2) Second Embodiment

The second embodiment will be described. This second embodiment will be described for the case where the invention utilizes a storage system in which a first storage apparatus and third storage apparatus connected to the host 300 are provided; a virtual volume is formed above devices in each of the first and third storage apparatuses; the virtual volume is subjected to data processing; and as a result, data processing can be executed simultaneously on respective predetermined devices in the first and third storage apparatuses.

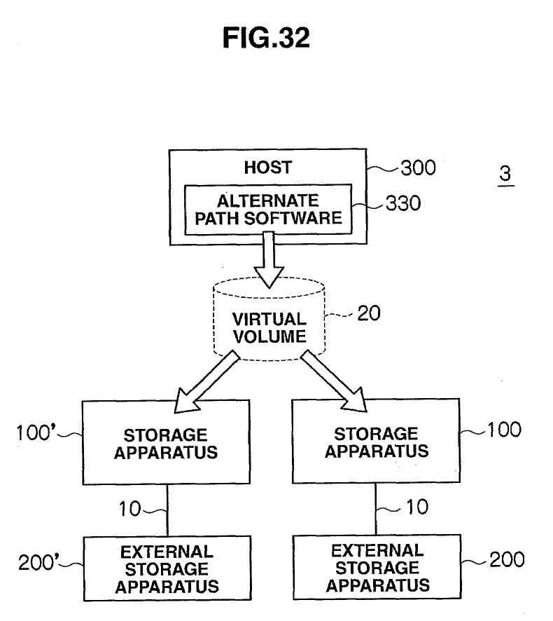

FIG. 32 is a diagram explaining a storage system 3 in the second embodiment. Note that the maintenance terminal 400 and the management apparatus 500 are provided in the storage system 3, like the storage system 1 described with reference to FIG. 1, but are not shown in the figure. The configuration not directly related to the second embodiment is not shown in the figure, either.

As shown in FIG. 32, the host 300 has alternate path software 330. When processing for, e.g., data write is executed on a virtual volume 20, data processing can be executed simultaneously on the respective devices (not shown in the figure) in the storage apparatus 100 and a storage apparatus 100′. Also, the external storage apparatus 200 and an external storage apparatus 200′ are respectively connected to the storage apparatus 100 and the storage apparatus 100′.

The alternate path software 330 may give a device re-recognition request to the storage apparatus 100 (including the external storage apparatus 200 as an external volume) and the storage apparatus 100′ (including the external storage apparatus 200′ as an external volume). During the device re-recognition, the alternate path software 330 needs to issue “Inquiry” commands to all the LUs in all the storage apparatuses connected to the host 300 to acquire LU information.

In the storage system 3 configured as above, regarding the volumes for which setting of the simultaneous data processing has been made, the serial number and LU number, which are included in the device identification information and control information, are set to the values set in the processing in the device detailed information format 970 described with reference to FIG. 25. By conducting the above setting, the same processing as that in the first embodiment can also be executed in the storage system 3. More specifically, port search processing and volume search processing can be executed based on the values set in the above processing, and therefore, the information about the connection paths to the volumes in the external storage apparatuses 200 and 200′ can be acquired.

Also, in the storage system 3, a setting can be employed in which selection is made concerning whether or not device detailed information is requested based on the values set in the above processing. Therefore, the device configuration report request command format 900, which has been described in the first embodiment, stores the information concerning whether or not device detailed information is requested.

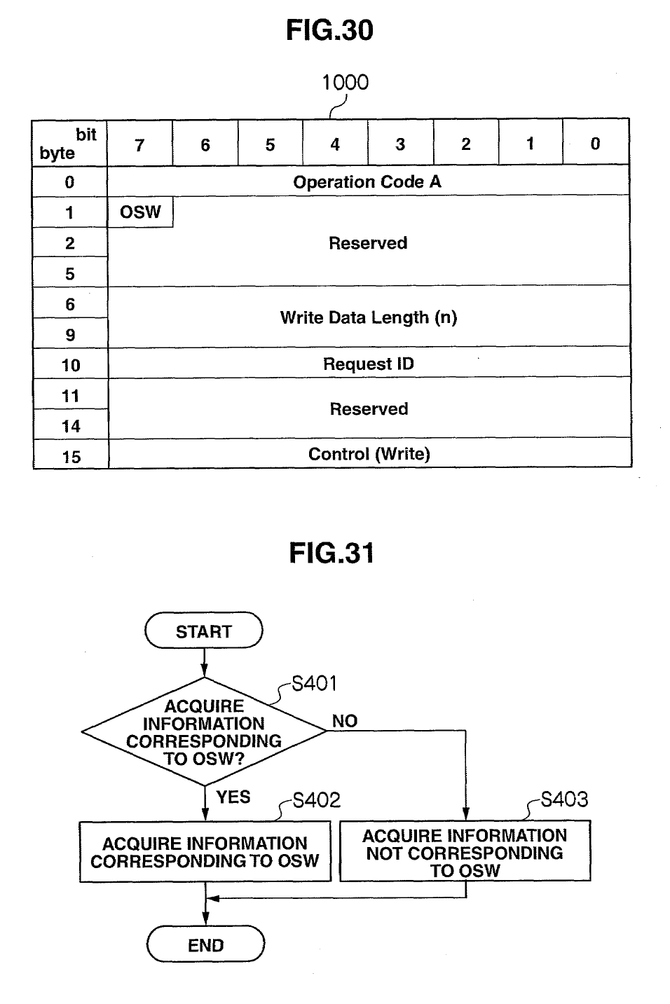

FIG. 30 is a diagram showing an example of a device configuration report request command format 1000 storing the information. The device configuration report request command format 1000 differs from the device configuration report request command format 900 in the first embodiment only on the point that the information is stored, and so a detailed description is omitted. The information that serves as “OSW” is stored in the “Reserved” area.

FIG. 31 is a flowchart showing processing for judging whether or not the storage apparatus 100 requests the acquisition of the information corresponding to the setting for the above processing according to an instruction from a user. The storage apparatus 100 judges whether or not “OSW” has been set in the device configuration report request command format 1000 (S401). If “OSW” has been set (S401: YES), the storage apparatus 100 acquires the information corresponding to OSW (information corresponding to the processing) (S402). Meanwhile, if “OSW” has not been set (S401: NO), the storage apparatus 100 acquires the information not corresponding to OSW (information not corresponding to the processing) (S403).

### Other Embodiments

The first embodiment has been described for the case where the invention utilizes the storage system: including the host 300, the storage apparatus 100; the external storage apparatus 200 connected to the storage apparatus 100 via the fibre cable 10; and the client PC 500 that manages the storage apparatus 100 and the external storage apparatus 200, the host 300 and the storage apparatus 100 being connected to each other via the fibre cable 10, and the host 300 using a volume in the external storage apparatus 200 as an external volume for the storage apparatus 100, in which the storage apparatus 100 includes the port search processing unit that searches for WWNs in the external storage apparatus 200 (S202) and a volume search processing unit that searches for connection paths to a volume in the external storage apparatus 200 by utilizing any of the WWNs found by the port search processing unit and outputs all the information about the found connection paths to the volume (S204). However, the invention is not limited to this configuration.

The client PC 500 sends the storage apparatus 100 an instruction to execute processing in the port search processing unit and processing in the volume search processing unit, and the found connection paths to the volume are output to the client PC 500 via the maintenance terminal 400. However, the invention is not limited to this configuration.

Also, the configuration has been described in which, as shown in FIG. 16, in volume search processing, the number-of-devices request, in which a command for requesting the number of devices corresponding to the external volume specified by the storage apparatus management unit 510 is sent to one of the communication ports; the number-of-devices acquisition, in which the number of devices obtained as a response to the request from the number-of-devices request unit is acquired; and the device configuration information acquisition, in which the acquisition of the device configuration information for the number of devices acquired by the number-of-devices acquisition unit is requested, are conducted. However, the invention is not limited to this configuration.

The client PC 500 has been described for the case where it creates the external volume information 830 based on the device configuration information obtained via the device configuration information acquisition, and creates the external volume list 810 for the external storage apparatus 200. The external volume information 830 has been described for the case where it includes the device identification information, device name, control information, path information, and alternate path information, as shown in FIG. 14. However, the invention is not limited to this configuration.

Moreover, the storage apparatus 100 has been described for the case where it has the external ports 101 and 102 for communicating with the external storage apparatus 200 via the fibre cable 10, and the connection path information has been described for the case where it consists of the combination of the specified external port (101,102), WWN on the fibre cable 10, and LUN. However, equivalents of the above can also be utilized in the invention.

Furthermore, the second embodiment has been described for the case where the invention utilizes the storage system 3 in which the storage system 1 further includes the storage apparatus 100′ connected to the host 300 and the external storage apparatus 200′ connected to the storage apparatus 100′ via the fibre cable 10; in which the host 300 uses a volume in the external storage apparatus 200′ as an external volume for the storage apparatus 100′; in which the host 300 includes the data processing unit for executing data processing simultaneously on the respective predetermined devices in the storage apparatus 100 and the storage apparatus 100′ by utilizing the virtual volume above the storage apparatus 100 and the storage apparatus 100′; and in which volume search processing (S204) is executed so that which—the acquisition of information corresponding to the setting (S402) or the acquisition of information not corresponding to the setting (S403)—is conducted is judged (S401) based on whether or not a setting for conducting the simultaneous data processing (presence or absence of OSW in FIG. 31) has been made when conducting the volume search. However, the invention is not limited to this configuration.

A wide variety of storage systems and external volume connection path search methods for the storage systems can be utilized in the invention.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A storage system comprising:
a host, a first storage apparatus, a second storage apparatus connected to the first storage apparatus via a communication line, and a management apparatus that manages the first storage apparatus and the second storage apparatus, the host and the first storage apparatus being connected to each other via the communication line; and the host using a volume in the second storage apparatus as an external volume for the first storage apparatus, wherein:
the first storage apparatus includes:
a port search processing unit that searches for communication ports of the second storage apparatus; and
a volume search processing unit that searches for connection paths to a volume in the second storage apparatus by utilizing any of the communication ports found by the port search processing unit and outputs all the information about the found connection paths to the volume.

2. The storage system according to claim 1, wherein the management apparatus sends the first storage apparatus an instruction to execute processing in the port search processing unit and an instruction to execute processing in the volume search processing unit.

3. The storage system according to claim 1, wherein the volume search processing unit outputs information about the connection paths to the volume to the management apparatus.

4. The storage system according to claim 1, wherein the volume search processing unit includes:
a number-of-devices request unit that sends any of the communication ports a command to request the number of devices corresponding to an external volume specified by the management apparatus;
a number-of-devices acquisition unit that acquires the number of devices given as a response to a request from the number-of-devices request unit; and
a device configuration information acquisition unit that requests acquisition of configuration information for the number of devices acquired by the number-of-devices acquisition unit.

5. The storage system according to claim 4, wherein the management apparatus creates external volume information based on the device configuration information acquired in the device configuration information acquisition unit, and creates an external volume list for the second storage apparatus.

6. The storage system according to claim 5, wherein the external volume information includes device identification information, device name, control information, path information, and alternate path information.

7. The storage system according to claim 1, wherein the communication port is unique identification information on the communication line.

8. The storage system according to claim 7, wherein:
the first storage apparatus includes plural external connection ports for communicating with the second storage apparatus via the communication line; and
the connection path information consists of a combination obtained by specifying the external connection port, the unique identification information on the communication line, and a device corresponding to the volume.

9. The storage system according to claim 4, further comprising a third storage apparatus connected to the host and a fourth storage apparatus connected to the third storage apparatus via the communication line, wherein:
the host uses a volume in the fourth storage apparatus as an external volume for the third storage apparatus;
the host includes a data processing unit for executing data processing simultaneously on a predetermined device in each of the first storage apparatus and the third storage apparatus by utilizing a virtual volume above the first storage apparatus and the third storage apparatus; and
the volume search processing unit includes a judgment unit that judges, based on whether or not a setting for conducting the simultaneous data processing has been made when conducting the volume search, which is conducted between the acquisition of information corresponding to the setting and the acquisition of information not corresponding to the setting.

10. An external volume connection path search method for a storage system including: a host, a first storage apparatus, a second storage apparatus connected to the first storage apparatus via a communication line, and a management apparatus that manages the first storage apparatus and the second storage apparatus, the host and the first storage apparatus being connected to each other via the communication line; and the host using a volume in the second storage apparatus as an external volume for the first storage apparatus, comprising:
conducting port search for searching for communication ports of the second storage apparatus; and
searching for connection paths to the volume in the second storage apparatus by utilizing any of the communication ports found in port search processing, and outputting all the information about the found connection paths to the volume.

11. The external volume connection path search method for a storage system according to claim 10, further comprising sending the first storage apparatus an instruction to execute the port search processing and an instruction to execute the volume search processing.

12. The external volume connection path search method for a storage system according to claim 10, wherein the volume search step includes outputting the information about the connection paths to the volume to the management apparatus.

13. The external volume connection path search method for a storage system according to claim 10, wherein the volume search step includes:
sending any of the communication ports a command to request the number of devices corresponding to an external volume specified by the management apparatus;
acquiring the number of devices given as a response to a request; and
requesting acquisition of configuration information for the acquired number of devices.

14. The external volume connection path search method for a storage system according to claim 13, further comprising creating external volume information based on the device configuration information and creating an external volume list for the second storage apparatus.

15. The external volume connection path search method for a storage system according to claim 14, wherein the external volume information includes device identification information, device name, control information, path information, and information about alternate paths

16. The external volume connection path search method for a storage system according to claim 10, wherein the communication port is unique identification information on the communication line.

17. The external volume connection path search method for a storage system according to claim 16, wherein:
the first storage apparatus includes plural external connection ports for communicating with the second storage apparatus via the communication line; and
the connection path information consists of a combination obtained by specifying the external connection port, the unique identification information on the communication line, and a device corresponding to the volume.

18. The external volume connection path search method for a storage system according to claim 13, wherein
the storage system includes a third storage apparatus connected to the host and a fourth storage apparatus connected to the third storage apparatus via the communication line, and the host uses a volume in the fourth storage apparatus as an external volume for the third storage apparatus;
the host includes a data processing unit for executing data processing simultaneously on a predetermined device in each of the first storage apparatus and the third storage apparatus by utilizing a virtual volume above the first storage apparatus and the third storage apparatus; and
the method further includes step of judging, based on whether or not a setting for conducting the simultaneous data processing has been made when conducting the volume search, which is conducted between the acquisition of information corresponding to the setting and the acquisition of information not corresponding to the setting.
